(19) United States
(12) Patent Application Publication
(10) Pub. No.: US 2015/0222782 A1
(43) Pub. Date: Aug. 6, 2015

(54) DEVICE CONTROL APPARATUS AND CONTROL METHOD THEREOF

(71) Applicant: CANON IMAGING SYSTEMS INC., Niigata-shi (JP)

(72) Inventors: Satoshi NEGISHI, Niigata-shi (JP); Mamoru NAGANO, Niigata-shi (JP)

(21) Appl. No.: 14/684,787

(22) Filed: Apr. 13, 2015

Related U.S. Application Data
(63) Continuation of application No. PCT/JP2013/078888, filed on Oct. 18, 2013.

(30) Foreign Application Priority Data
Oct. 22, 2012 (JP) 2012-232740
Oct. 3, 2013 (JP) 2013-208659

(51) Int. Cl. H04N 1/32; H04N 1/00

(52) U.S. Cl. CPC H04N 1/32128; H04N 1/00209; H04N 1/00127; H04N 2201/0094; H04N 2201/0065

(57) ABSTRACT

A device control apparatus which can remotely control an information processing apparatus on a network using an internal device is provided. The device control apparatus 20 transmits virtual device identification information 204 identified for recognizing the internal device 40 as a device under virtualization control to the information processing apparatus 10, relays data communication using USB data performed with the internal device 40 while the information processing apparatus 10 performs virtualization control on the internal device 40 based on the virtual device identification information 204, and converts the relayed USB data into a first data format used for data communication with the internal device 40 and into a second data format used for data communication with the information processing apparatus 10.

### BACKGROUND OF THE INVENTION

1. Field of the Invention

The present invention relates to a device control apparatus for processing various requests transmitted from an information processing apparatus connected via a network, and a control method thereof.

2. Description of the Related Art

In recent years, with the widespread use of networks, a client PC which is an information processing apparatus on a network, has utilized a device such as a printer, a storage and a scanner as a shared device via a device server, and there have been proposed some methods for realizing this configuration.

For example, the applicant of the present application has proposed a device control system in which a device server monitors a change of an operation state of a device locally connected to the device server itself, and, when detecting a change of a state of the device, notifies a client PC of information indicative of a detection result of the change of the state, and the client PC controls the device while recognizing as if the device were locally connected as necessary from this information indicative of the detection result (hereinafter, referred to as “virtualization control”) (see, for example, International Publication No. WO 2011/055831).

However, in the device control system disclosed in International Publication No. WO 2011/055831 which has been proposed by the applicant prior to the present application, there is, for example, a case where it is desired to implement printing or scanning by remotely controlling the client PC on the network from an operation panel (such as a keyboard and a numerical keypad) provided at a device such as a printer and a multifunctional peripheral device.

### SUMMARY OF THE INVENTION

It is therefore an object of the present invention to provide a device control apparatus which can remotely control a client PC (information processing apparatus) on a network using an input device. (such as a keyboard and a numerical keypad) and a display device (hereinafter, referred to as “internal device”) provided at the device, and a control method thereof.

To achieve the above object, according to the present invention, it is provided a device control apparatus connected to an information processing apparatus via a network, comprising an identification information storing means which stores virtual device identification information identified for recognizing a predetermined function of the device control apparatus as an internal device connected to the device control apparatus, an identification information transmitting means which transmits the virtual device identification information to the information processing apparatus, and a virtualization control means which controls the internal device recognized based on the virtual device identification information by the information processing apparatus according to a control request from the information processing apparatus while converting data communication between the internal device and the device control apparatus into a first data format and converting data communication between the information processing apparatus and the device control apparatus into a second data format.

According to the present invention, it is provided a control method of a device control apparatus connected to an information processing apparatus via a network, the device control apparatus comprising an identification information storing means which stores virtual device identification information identified for recognizing a predetermined function of the device control apparatus as an internal device connected to the device control apparatus, the method comprising an identification information transmitting step of transmitting the virtual device identification information to the information processing apparatus, and a virtualization control step of controlling the internal device recognized based on the virtual device identification information by the information processing apparatus according to a control request from the information processing apparatus, while converting data communication between the internal device and the device control apparatus into a first data format and converting data communication between the information processing apparatus and the device control apparatus into a second data format.

According to the present invention, because the internal device which is a predetermined function of the device control apparatus is under virtualization control of the information processing apparatus via the network while data communication between the internal device and the device control apparatus is converted into the first data format and data communication between the information processing apparatus and the device control apparatus is converted into the second data format, it is possible to operate the information processing apparatus on the network using the internal device.

Further features of the present invention will become apparent from the following description of exemplary embodiments with reference to the attached drawings.

### BRIEF DESCRIPTION OF THE DRAWINGS

FIG. 1 is a block diagram schematically showing a configuration of an example of a device control system according to a first embodiment of the present invention.

FIG. 2 is a table showing an example of virtual device identification information shown in FIG. 1.

FIG. 3 is a sequence diagram useful in explaining an operation when an information processing apparatus performs virtualization control on an internal device provided at a device control apparatus in the device control system shown in FIG. 1.

FIG. 4 is a drawing showing an example of an operation screen displayed at a display device shown in FIG. 1.

FIG. 5 is a sequence diagram useful in explaining an operation when the information processing apparatus performs virtualization control on an external device connected to the device control apparatus in the device control system shown in FIG. 1.

FIG. 6 is a flowchart useful in explaining processing performed by the information processing apparatus shown in FIG. 1.

FIG. 7 is a flowchart useful in explaining processing according to the external device performed by the device control apparatus shown in FIG. 1.

FIG. 8 is a flowchart useful in explaining processing according to the internal device performed by the device control apparatus shown in FIG. 1.

FIG. 9 is a block diagram schematically showing a configuration of an example of a device control system according to a second embodiment of the present invention.

FIG. 10A is a sequence diagram useful in explaining processing when a storing unit and a touch panel are under virtualization control of an information processing apparatus in the device control system shown in FIG. 9.

FIG. 10B is a sequence diagram useful in explaining processing when a storing unit and a touch panel are under virtualization control of an information processing apparatus in the device control system shown in FIG. 9.

FIG. 11 is a drawing showing an example of an operation screen displayed on the touch panel of a device control apparatus shown in FIG. 9.

FIG. 12 is a drawing showing an example of a state where a screen of application activated at the information processing apparatus is displayed on the touch panel shown in FIG. 9.

FIG. 13 is a drawing showing an example of an encryption information input screen displayed on the touch panel shown in FIG. 9.

FIG. 14 is a sequence diagram useful in explaining processing when the storing unit and the touch panel are under virtualization control of the information processing apparatus to use a printer and a scanner provided at an MFP in the device control system shown in FIG. 9.

### DESCRIPTION OF THE EMBODIMENTS

An example of a device control system according to embodiments of the present invention will be described below with reference to the drawings.

### First Embodiment

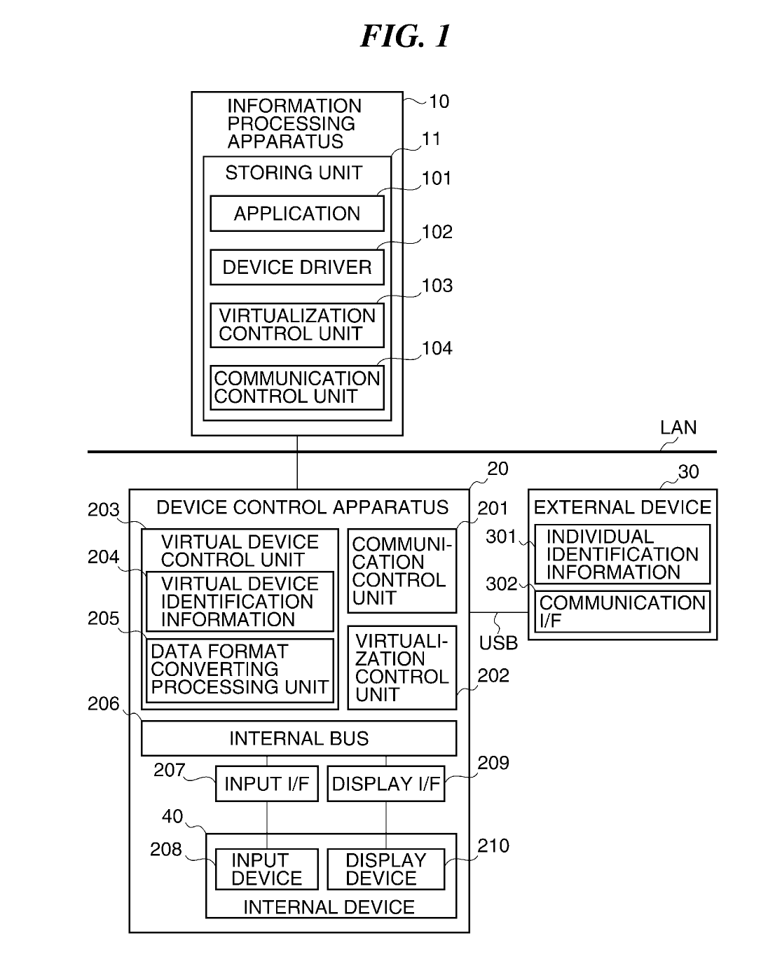

FIG. 1 is a block diagram schematically showing a configuration of an example of a device control system according to a first embodiment of the present invention.

In the device control system shown in FIG. 1, an information processing apparatus 10 is connected to a device control apparatus 20 via a local area network (LAN). The LAN is configured with a wired line or a wireless line. An external device 30 is locally connected to the device control apparatus 20 through, for example, a communication interface (for example, USB or HDMI).

The information processing apparatus 10 which is an apparatus such as a personal computer (PC) utilized by a user, includes a device driver 102 installed therein for controlling the external device 30 connected to the device control apparatus 20 and an internal device 40 provided at the device control apparatus 20. This device driver 102 is typically software provided by a manufacturer, and the information processing apparatus 10 is capable of controlling the above-described internal device 40 and external device 30 using the device driver 102 supporting each device.

It should be noted that the device control apparatus 20 has a function which makes it possible to use at the information processing apparatus 10, the external device 30 connected to the device control apparatus 20 and the internal device 40 provided at the device control apparatus 20 in a similar manner to a case where these devices 30 and 40 are directly connected (locally connected) to the information processing apparatus 10.

As described above, the external device 30 is externally connected to the device control apparatus 20 through a USB interface. Further, the internal device 40 is connected to each component of hardware of the device control apparatus 20 through an internal bus 206.

It should be noted that while only one information processing apparatus 10, one device control apparatus 20 and one external device 30 are shown in the device control system shown in FIG. 1, the number of the information processing apparatuses 10, the device control apparatuses 20 and the external devices 30 is not limited to the example shown in the drawing. Further, while the device control apparatus 20 is shown as, for example, office equipment such as a printer and a multifunctional peripheral device, the device control apparatus 20 is not limited to the office equipment and may be various embedded devices, mobile phones or mobile terminal equipment.

A communication interface of the external device 30 is not limited to USB or HDMI. Further, while the internal device 40 includes an input device 208 and a display device 210 in the example shown in the drawing, it is also possible to use a touch panel provided at the display device 210 as the input device 208.

Further, it is also possible to configure the device control system only with the information processing apparatus 10 and the device control apparatus 20 without connecting the external device 30 to the device control apparatus 20.

Although not shown in FIG. 1, the information processing apparatus 10 includes a CPU, an input unit, a display unit, a memory, a communication unit, a storing unit and so on as hardware configurations, and these hardware components are interconnected through the internal bus.

The CPU administers the whole control of the information processing apparatus 10. The input unit includes, for example, a keyboard and a mouse. For example, a liquid crystal monitor is used as the display unit. The memory is, for example, a RAM and a ROM.

The communication unit, which is an interface for connecting to the LAN, transmits/receives data with the device control apparatus 20, thereby enabling the information processing apparatus 10 to transmit/receive data with the external device 30 locally connected to the device control apparatus 20 and the internal device 40 provided at the device control apparatus 20.

A storing unit 11 stores an operating system which is software (hereinafter, referred to as “OS”, not shown), a communication control unit 104, a virtualization control unit 103, the device driver 102 and application 101, and also stores software relating to other functions. It should be noted that these sets of software are read out to the memory and operate according to control from the CPU.

The application 101 is software for controlling the external device 30 and the internal device 40 by issuing a data input/output request to the device driver 102.

The device driver 102 converts the data input/output request from the OS or the application 101 into data (hereinafter, referred to as “control command”) in a data format corresponding to the external device 30 and the internal device 40 and transmits the control command to the virtualization control unit 103. Further, the device driver 102 notifies the application 101 of a response to the control command.

The virtualization control unit 103 converts the control command (i.e., data input/output request) transmitted from the device driver 102 into packet data (hereinafter, referred to as “USB data”) complying with a USB data format. Further, the virtualization control unit 103 converts USB data transmitted from the communication control unit 104 into the same data format as the control command and transmits the converted USB data to the device driver 102.

Still further, the virtualization control unit 103 has a function (hereinafter, referred to as a “virtualization control function”) of simulating the same behavior as behavior performed in a case where the external device 30 and the internal device 40 are directly connected (locally connected) to the information processing apparatus 10 in response to a data transmission/reception request to the external device 30 and the internal device 40. This virtualization control function enables the information processing apparatus 10 to transmit/receive data while making the information processing apparatus 10 recognize that connection states of the external device 30 and the internal device 40 are the same as a case where these devices 30 and 40 are locally connected.

The communication control unit 104 controls data transmission/reception between the device control apparatus 20 and the information processing apparatus 10 while performing converting processing between USB data transmitted from the virtualization control unit 103 and a network packet for performing communication with the device control apparatus 20 through the LAN. Further, the communication control unit 104 controls start and disconnection of a session between the device control apparatus 20 and the information processing apparatus 10 according to the data transmission/reception request transmitted from the application 101 or the device driver 102 via the virtualization control unit 103.

The device control apparatus 20, which is, for example, peripheral equipment such as a printer and a multifunctional peripheral device, includes a CPU, a memory, a communication unit, a storing unit, and so on (not shown) as hardware configurations, and also includes the internal device 40. In the example shown in the figure, the internal device 40 (input and output device) includes the input device 208 and the display device 210 used as user interfaces. The input device 208 and the display device 210 are respectively connected to the internal bus 206 through an input interface (I/F) 207 and a display I/F 209.

The CPU administers the whole control of the device control apparatus 20. The input device 208 is, for example, input equipment such as a keyboard, a numerical keypad and a mouse or a software keyboard which realizes these functions using software. For example, a liquid crystal monitor is used as the display device 210. The memory is, for example, a RAM and a ROM.

The communication unit, which is an interface for connecting to the LAN, transmits/receives data with the information processing apparatus 10.

The storing unit stores an OS (not shown) which is software, a communication control unit 201 and a virtualization control unit 202, and also stores software relating to other functions. These sets of software are read out to the memory and operate according to control from the CPU.

The communication control unit 201 controls transmission/reception of input/output data, or the like performed with the information processing apparatus 10. The virtualization control unit 202 controls the external device 30 and the internal device 40 according to (in conjunction with) a control request from the virtualization control unit 103 of the information processing apparatus 10 so as to enable the information processing apparatus 10 to perform control while making the information processing apparatus 10 recognize as if the external device 30 connected to the device control apparatus 20 and the internal device 40 of the device control apparatus 20 were locally connected to the information processing apparatus 10.

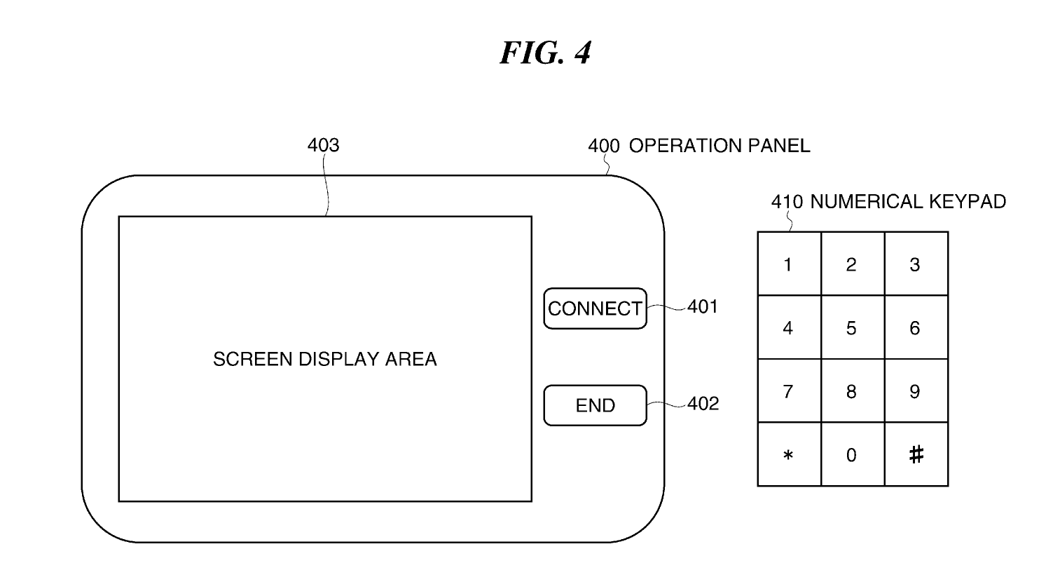

A virtual device control unit 203 includes virtual device identification information 204 and a data format converting processing unit 205. Further, the virtual device control unit 203 includes a switching unit (see, for example, FIG. 4 described later) such as a user interface for switching the internal device 40 of the device control apparatus 20 to a virtual USB device.

The virtual device identification information 204 is used for making the information processing apparatus 10 recognize the internal device 40 in a similar manner to the external device 30. Typically, because the input device 208 and the display device 210 which are the internal device 40, do not have information corresponding to individual identification information of the external device 30, the information processing apparatus 10 cannot recognize the internal device 40.

Accordingly, in this embodiment, the virtual device identification information 204 corresponding to the individual identification information is allocated to each of the input device 208 and the display device 210 to make the information processing apparatus 10 recognize the input device 208 and the display device 210 as USB devices similar to the external device 30. Here, information obtained by creating, in a pseudo manner, configuration information which defines a data structure of the USB device (hereinafter, referred to as a “USB descriptor”) is defined as the virtual device identification information 204. The virtual device identification information 204 is stored in advance in the virtual device control unit 203, however, it may be created by the virtual device control unit 203.

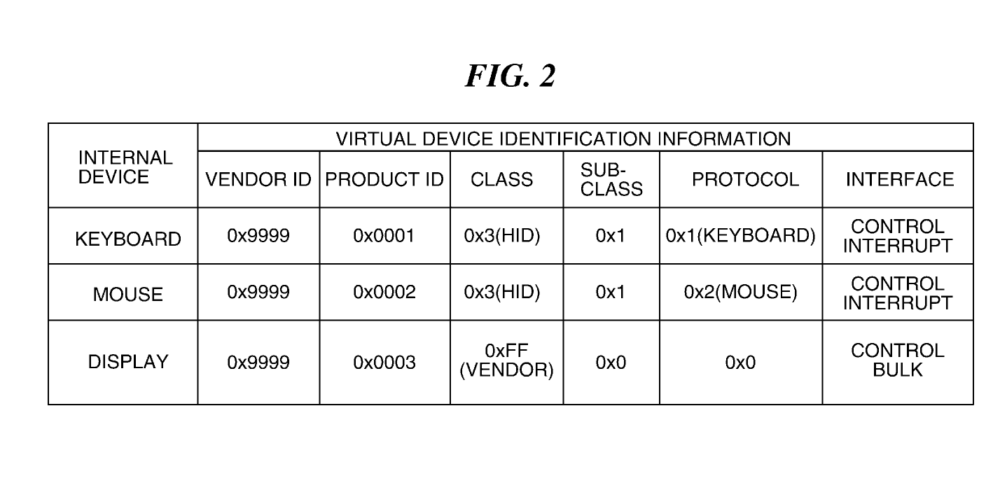

FIG. 2 is a drawing showing an example of the virtual device identification information 204 shown in FIG. 1, in which the virtual device identification information 204 is comprised of USB descriptors

The input device 208 corresponds to a keyboard and a mouse, and the display device 210 corresponds to a display. In order that the keyboard, the mouse and the display may be recognized as the USB devices, pseudo USB descriptors (i.e., virtual device identification information) are respectively allocated to the keyboard, the mouse and the display.

Each of the pseudo USB descriptors shown in FIG. 2 is made up of a vendor ID, a product ID, a serial number, a class, a sub-class, a protocol and an interface.

The vendor ID is identification information allocated for each enterprise and manufacturer, and the product ID is a code allocated for each product or for each model by the enterprise and the manufacturer having the vendor ID so as not to overlap with each other. In this embodiment, the vendor ID and the product ID allocated to the device control apparatus 20 are used.

Further, the class, the sub-class, the protocol and the interface are information defined by the USB standard according to types of devices such as a keyboard, a mouse and a display. The pseudo USB descriptors which associate the vendor IDs, the product IDs, the classes, the sub-classes, the protocols and the interfaces are created and held (stored) by the virtual device control unit 203 as the virtual device identification information 204.

Here, when a connection operation for starting connection to the internal device 40 is performed with respect to the input device 208 through a user operation, or the like, the virtual device control unit 203 transmits the virtual device identification information 204 to the virtualization control unit 202. Meanwhile, when an end operation is performed, the virtualization control unit 202 ends virtualization control of the internal device 40.

A data format converting processing unit 205 performs converting processing between packet data (USB data) complying with a USB data format transmitted from the virtualization control unit 202 and data in a data format which can be processed by the internal device 40 to enable data transmission/reception between the input I/F 207 and the display I/F 209 connected to the internal device 40, and the information processing apparatus 10.

In this embodiment, the virtual device control unit 203 transmits a USB descriptor of which an HID class has been identified to the virtualization control unit 202 as the virtual device identification information 204 associated with the input device 208 such as a keyboard and a mouse. Further, the data format converting processing unit 205 converts input data input from the input device 208 into USB data of the HID class and transmits the converted USB data to the virtualization control unit 202 via the input I/F 207.

Further, the virtual device control unit 203 transmits a USB descriptor of which vendor specific information (vendor class) has been identified to the virtualization control unit 202 as the virtual device identification information 204 associated with the display device 210 such as a display. Still further, the data format converting processing unit 205 converts USB data transmitted from the virtualization control unit 202 into a data format for the display device 210 and transmits the converted USB data to the display device 210 via the display I/F 209.

For example, when the information processing apparatus 10 on the network is remotely operated from a touch panel provided at the device control apparatus 20, the virtual device identification information 204 as described above is transmitted to the information processing apparatus 10 on the network according to a switching operation from the touch panel to switch control of the touch panel which is the internal device 40 (i.e., keyboard input and display output) to virtualization control from the information processing apparatus 10 on the network. By this means, it is possible to remotely operate the information processing apparatus 10 on the network from the touch panel provided at the device control apparatus 20.

As described above, the internal device 40 is an input/output apparatus such as the input device 208 and the display device 210, which are respectively connected to the internal bus 206 via the input I/F 207 and the display I/F 209. The input device 208 which processes input from the keyboard, the mouse, the numerical keypad, or the like, is used upon operation of the device control apparatus 20.

For example, a liquid crystal display is used as the display device 210. The display device 210 may be provided with a touch panel, in which case the display device 210 has a function as an input unit. The internal bus 206 interconnects blocks of the device control apparatus 20 to perform transmission/reception of various data and to supply power.

The external device 30 which is, for example, an input device such as a keyboard, a mouse and a numerical keypad, a display device such as a CRT and a liquid crystal display, a storage apparatus such as a USB memory, or the like, is connected to the device control apparatus 20 through a communication I/F 302 such as a USB interface.

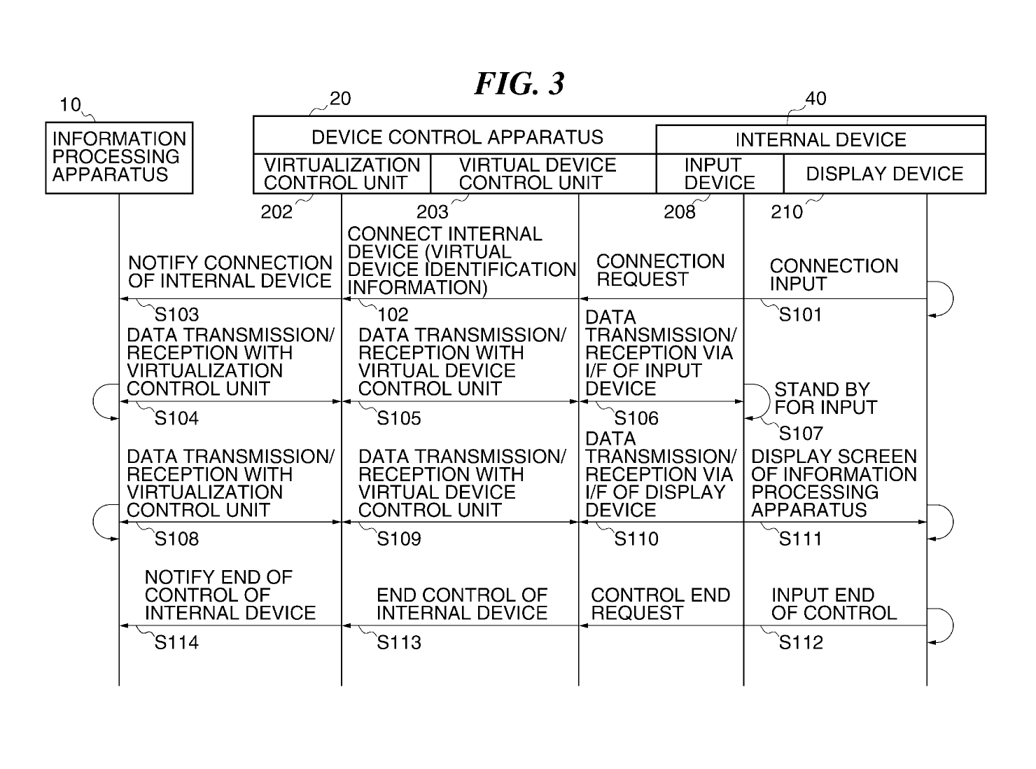

FIG. 3 is a sequence diagram useful in explaining an operation when the information processing apparatus 10 performs virtualization control on the internal device 40 provided at the device control apparatus 20 in the device control system shown in FIG. 1.

First, virtualization control of the internal device 40 is started through a user operation from the device control apparatus 20.

Specifically, a user performs a predetermined operation to make the display device 210 display an operation screen, operates (operates to connect) the input device 208 to start connection with the internal device 40 (step S101).

FIG. 4 is a diagram showing an example of an operation screen for instructing start and end of virtualization control displayed at an operation panel which is the display device 210.

In FIG. 4, when the user executes a predetermined operation using the operation panel 400 or a numerical keypad 410, the operation screen is displayed on the operation panel 400. The operation screen is comprised of a connect button 401 for instructing start of virtualization control of the internal device 40, an end button 402 for instructing end, and a screen display area 403 for displaying screen data from the information processing apparatus 10.

When the user depresses the connect button 401, virtualization control of the internal device 40 by the information processing apparatus 10 is started. Meanwhile, when the user depresses the end button 402, virtualization control of the internal device 40 by the information processing apparatus 10 ends, and the operation panel 400 of the device control apparatus 20 is switched to a normal display state. At the screen display area 403, the screen data transmitted from the information processing apparatus 10 is displayed. It should be noted that this screen data is obtained by converting data into a data format which can be displayed at the screen display area 403 at the data format converting processing unit 205.

Returning to explanation of the sequence in FIG. 3, when the user depresses the connect button 401 for displaying the operation screen of the operation panel 400, the virtual device control unit 203 transmits the virtual device identification information 204 of the input device 208 and the display device 210 to the virtualization control unit 202 to notify connection (transmit identification information: step S102). Subsequently, the virtualization control unit 202 notifies the information processing apparatus 10 that the input device 208 and the display device 210 are connected (step S103).

The information processing apparatus 10 starts virtualization control of the input device 208 via the virtualization control unit 202 and the virtual device control unit 203 and executes data transmission/reception (data communication) with the virtualization control unit 202 (step S104). The virtualization control unit 202 starts data transmission/reception with the virtual device control unit 203 (step S105).

Subsequently, the virtual device control unit 203 converts input data received through the input I/F 207 into USB data (a second data format) and transmits the USB data to the virtualization control unit 202 (step S106). The input device 208 stands by for input to the information processing apparatus 10 (step S107).

The information processing apparatus 10 starts virtualization control of the display device 210 via the virtualization control unit 202 and the virtual device control unit 203, and starts data transmission/reception with the virtualization control unit 202 (step S108). The virtualization control unit 202 starts data transmission/reception with the virtual device control unit 203 (step S109).

The data format converting processing unit 205 of the virtual device control unit 203 converts the USB data transmitted from the virtualization control unit 202 into a data format (a first data format) of the display device 210 and starts data transmission/reception through the display I/F 209 (step S110). The display device 210 displays a screen according to the screen data transmitted from the information processing apparatus 10 (step S111). In this way, the virtualization control unit 202 and the virtual device control unit 203 relay data communication between the internal device 40 and the information processing apparatus 10.

When the virtualization control is started, image data (for example, an image displayed at a liquid crystal monitor connected to the information processing apparatus 10) transmitted from the information processing apparatus 10 is displayed at the screen display area 403 of the operation panel 400 of FIG. 4. Further, through the operation of the numerical keypad 410, or the like, it is possible to perform an input operation on the information processing apparatus 10 in a similar manner to the operation performed through the keyboard and the numerical keypad of the information processing apparatus 10.

The user depresses the end button 402 displayed at the operation panel 400 shown in FIG. 4 to end the virtualization control of the internal device 40 by the information processing apparatus 10 (step S112). By this means, the virtual device control unit 203 notifies the virtualization control unit 202 that the control of the internal device 40 ends and ends data transmission/reception with the input device 208 and the display device 210 (step S113). Subsequently, the virtualization control unit 202 notifies the information processing apparatus 10 that control of the internal device 40 ends (end notification) (step S114). By this means, the virtualization control of the internal device 40 by the information processing apparatus 10 ends and the operation panel 400 of the device control apparatus 20 is switched to a normal display state.

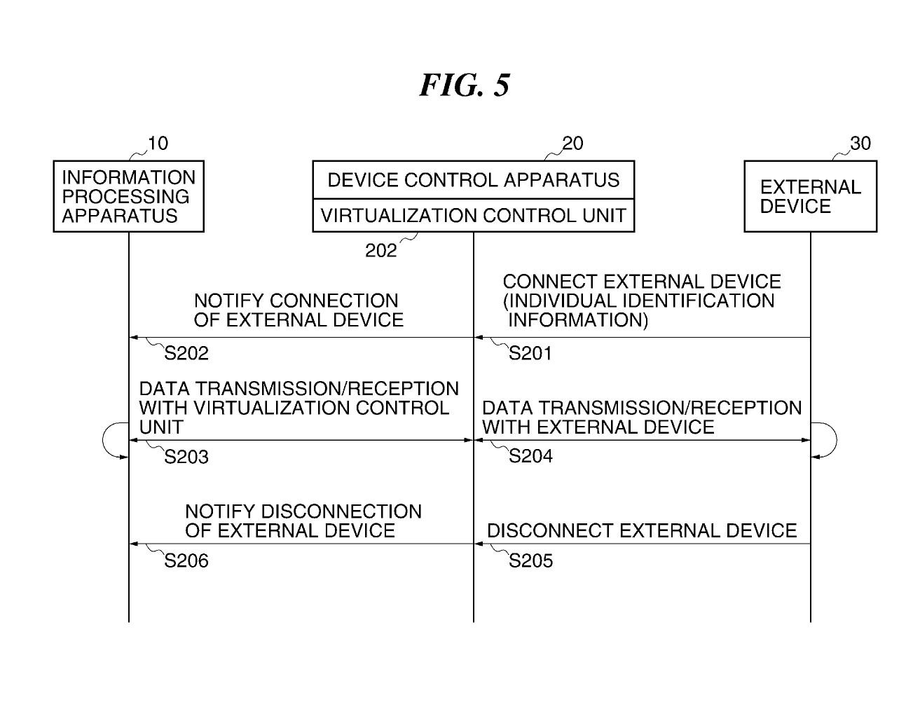

FIG. 5 is a sequence diagram useful in explaining an operation when the information processing apparatus 10 performs virtualization control on the external device 30 connected to the device control apparatus 20 in the device control system shown in FIG. 1.

In the example shown in the figure, virtualization control is started by connection of the external device 30 to the device control apparatus 20 through the communication I/F 302 such as a USB interface.

First, the user connects the external device 30 to the device control apparatus 20. By this means, the individual identification information 301 of the external device 30 is transmitted to the device control apparatus 20 to notify that the external device 30 is connected (step S201).

The virtualization control unit 202 notifies the information processing apparatus 10 that the external device 30 is connected (step S202). By this notification, the information processing apparatus 10 starts virtualization control of the external device 30 via the virtualization control unit 202, and starts data transmission/reception with the virtualization control unit 202 (step S203).

The virtualization control unit 202 starts data transmission/reception with the external device 30 through the communication I/F 302 (i.e., in a third data format) (step S204). Next, after data transmission/reception between the information processing apparatus 10 and the external device 30 via the device control apparatus 20 is completed, the external device 30 is disconnected from the device control apparatus 20 through the user operation, or the like (step S205). When detecting this disconnection, the virtualization control unit 202 of the device control apparatus 20 notifies the information processing apparatus 10 that the external device 30 is disconnected (step S206). By this notification, the virtualization control of the external device 30 by the information processing apparatus 10 ends.

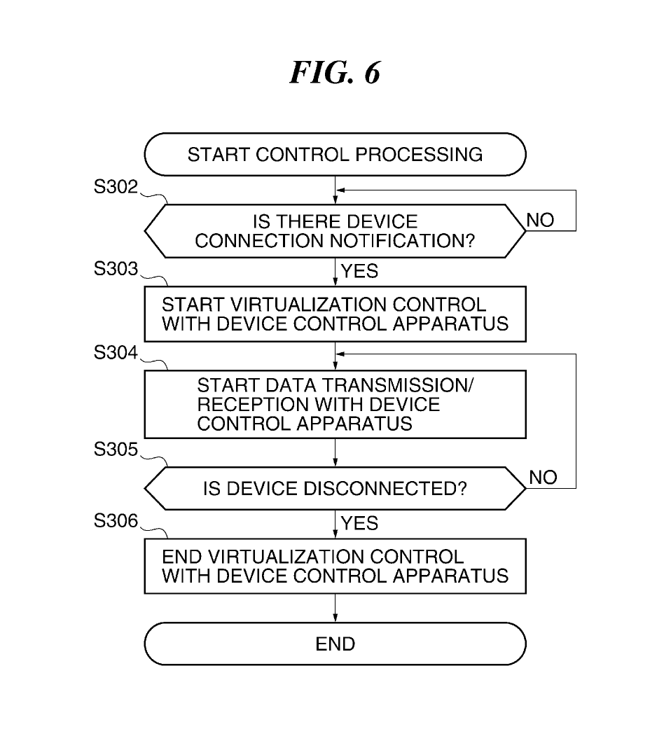

FIG. 6 is a flowchart showing virtualization control processing performed by the information processing apparatus 10 shown in FIG. 1.

The information processing apparatus 10 determines whether or not there is a device connection notification from the device control apparatus 20 in processing of detecting a device connection notification (step S302). When there is no device connection notification (No in the step S302), the information processing apparatus 10 stands by.

Meanwhile, when there is a device connection notification (Yes in the step S302), the information processing apparatus 10 starts virtualization control with the device control apparatus 20 (step S303). Further, the information processing apparatus 10 starts data transmission/reception with the device control apparatus 20 (step S304).

Subsequently, the information processing apparatus 10 determines whether or not the information processing apparatus 10 receives a device disconnection notification or a control end notification in processing of detecting disconnection of the device or the end of control (step S305). When the device is being connected (step S305), the information processing apparatus 10 returns to the processing in the step S304 and continues the data transmission/reception with the device control apparatus 20.

Meanwhile, when the information processing apparatus 10 receives a device disconnection notification or a control end notification (step S305), the information processing apparatus 10 ends the virtualization control with the device control apparatus 20 (step S306). The information processing apparatus 10 then returns to the step S302 and restarts the processing of detecting a device connection notification.

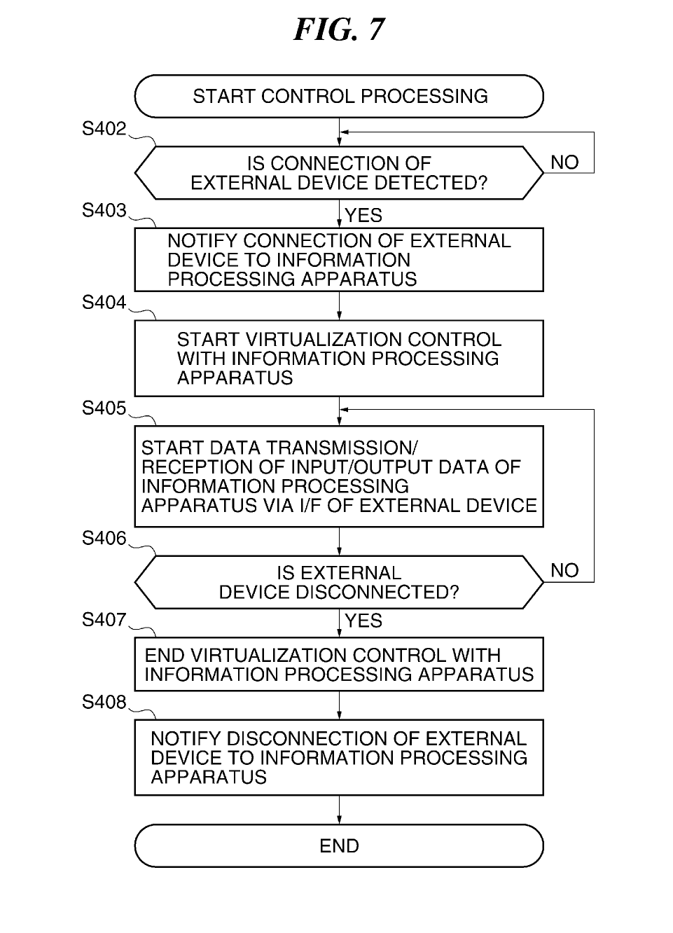

FIG. 7 is a flowchart showing processing relating to virtualization control of the external device 30 performed by the device control apparatus 20 shown in FIG. 1.

The device control apparatus 20 detects whether or not the external device 30 is connected in processing of detecting an external device connection notification (step S402). When connection of the external device 30 is not detected (step S402), the device control apparatus 20 stands by until the connection is detected.

Meanwhile, when detecting connection of the external device 30 (step S402), the device control apparatus 20 notifies the information processing apparatus 10 that the external device 30 is connected (step S403). Further, when virtualization control of the external device 30 by the information processing apparatus 10 is started (step S404), the device control apparatus 20 starts (relays) data transmission/reception between the information processing apparatus 10 and the external device 30 (step S405).

Subsequently, the device control apparatus 20 detects whether or not the external device 30 is disconnected in processing of detecting disconnection of the external device (step S406). When the external device 30 is being connected (step S406), the device control apparatus 20 returns to the processing in the step S405 and continues the data transmission/reception between the information processing apparatus 10 and the external device 30.

Meanwhile, when detecting disconnection of the external device 30 (step S406), the device control apparatus 20 ends the data transmission/reception (relay) with the external device 30 which is under virtualization control of the information processing apparatus 10 (step S407), notifies the information processing apparatus 10 that the external device 30 is disconnected and ends the virtualization control of the external device 30 (step S408). Further, the device control apparatus 20 returns to the step S402 again and restarts processing of detecting connection of an external device.

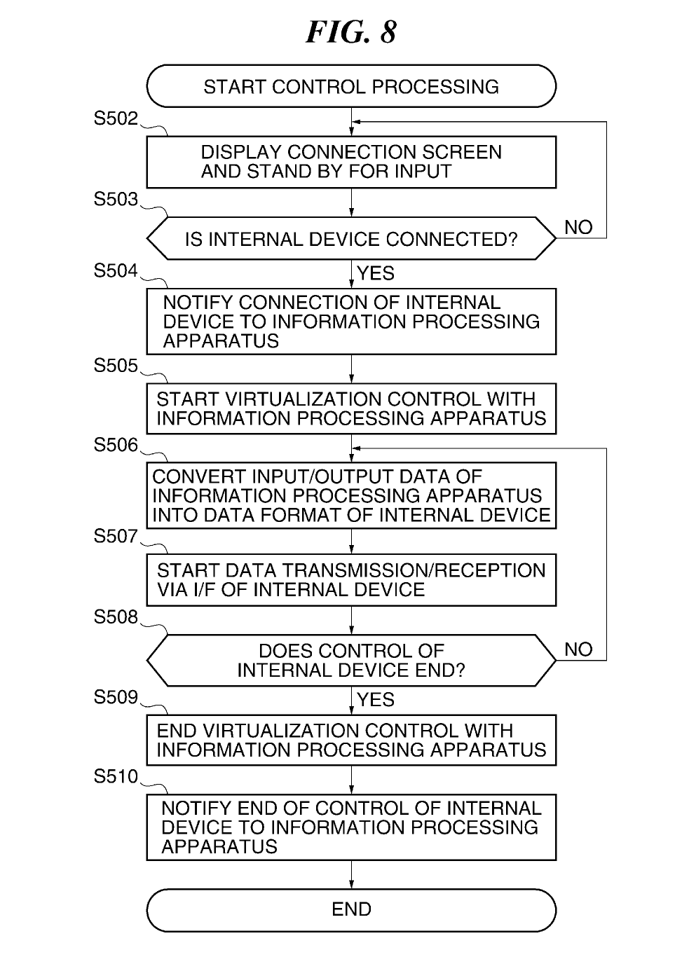

FIG. 8 is a flowchart useful in explaining processing relating to virtualization control of the internal device 40 performed at the device control apparatus 20 shown in FIG. 1, which will be described with reference to FIG. 4.

First, the device control apparatus 20 displays the operation screen shown in FIG. 4 at the operation panel 400 of the display device 210 through the user operation and stands by for input by the user (step S502). Further, the device control apparatus 20 determines whether or not the user connects the internal device 40 through, for example, depressing of the connect button 401, in processing of detecting connection of an internal device (step S503).

When connection of the internal device 40 is not detected (step S503), the device control apparatus 20 returns to the processing in the step S502 and stands by. Meanwhile, when detecting that the internal device 40 is connected through, for example, depressing of the connect button 401 shown in FIG. 4 (step S503), the device control apparatus 20 notifies the information processing apparatus 10 that the internal device 40 is connected (step S504). Further, the device control apparatus 20 starts virtualization control with the information processing apparatus 10 (step S505). When the virtualization control is started, data communication between the information processing apparatus 10 and the internal device 40 is implemented.

Subsequently, when receiving input/output data associated with the information processing apparatus 10, the data format converting processing unit 205 of the device control apparatus 20 converts the input/output data into a data format of the internal device 40 (step S506), and starts data transmission/reception with the internal device 40 through the input I/F 207 and the display I/F 209 (step S507).

The device control apparatus 20 detects whether or not control of the internal device 40 ends in processing of detecting the end of control of the internal device (step S508). When the end of control of the internal device 40 is not detected, that is, when the internal device 40 is being connected (step S508), the device control apparatus 20 returns to the processing in the step S506 and continues processing of converting the data format.

Meanwhile, when it is detected that the control of the internal device 40 ends through, for example, depressing of the end button 402 shown in FIG. 4 (step S508), the device control apparatus 20 ends data transmission/reception (relay) with the internal device 40 which is under virtualization control of the information processing apparatus 10 (step S509), and notifies the information processing apparatus 10 that control of the internal device 40 ends (step S510). By this means, the virtualization control of the internal device 40 by the information processing apparatus 10 ends and the operation panel 400 of the device control apparatus 20 is switched to a normal display state.

As described above, in the first embodiment of the present invention, because the information processing apparatus 10 performs virtualization control on the internal device 40 provided at the device control apparatus 20, so that the virtualization control unit 103 can simulate the same behavior as behavior performed in a case where the internal device 40 is directly connected (locally connected) to the information processing apparatus 10 using the device driver 102, the user can utilize the information processing apparatus 10 using the internal device 40 (for example, a keyboard, a numerical keypad and a display) provided at the device control apparatus 20.

Further, because the device driver 102 associated with the external device 30 and the internal device 40 provided at the device control apparatus 20 is installed at the information processing apparatus 10 side, it is not necessary to install at the device control apparatus 20 a device driver associated with the external device 30 and the internal device 40 provided at the device control apparatus 20.

### Second Embodiment

Next, an example of a device control system according to a second embodiment of the present invention will be described below.

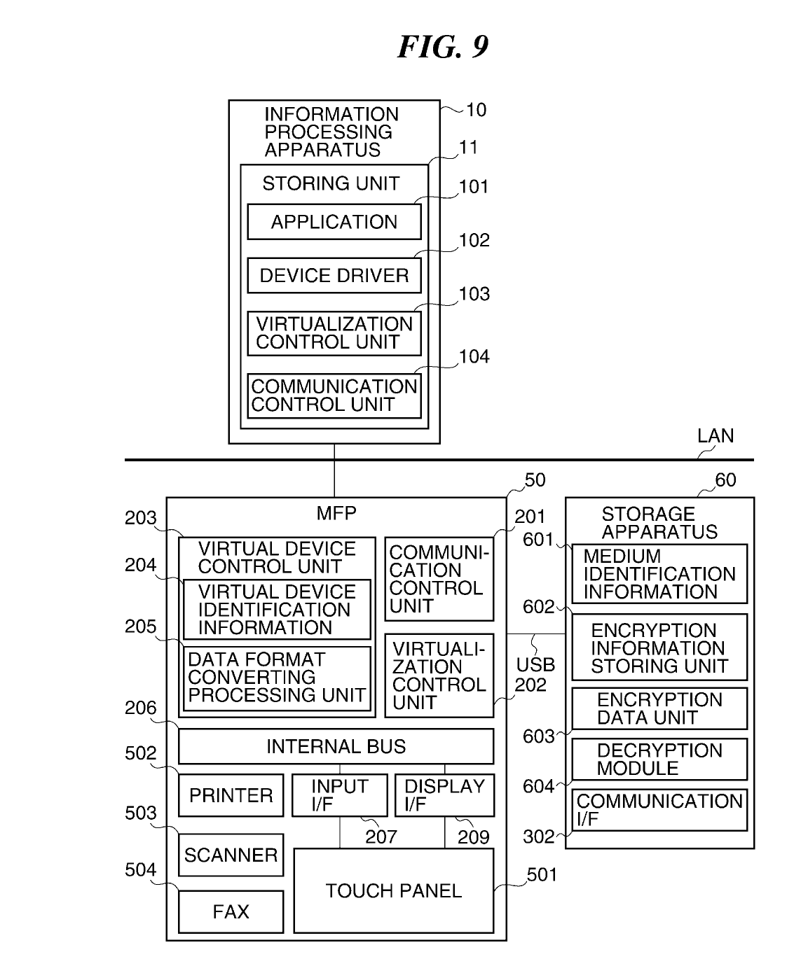

FIG. 9 is a block diagram schematically showing a configuration of the example of the device control system according to the second embodiment of the present invention. It should be noted that the same reference numerals are assigned to the same components as those in the device control system shown in FIG. 1, and its explanation will be omitted.

In the device control system shown in FIG. 9, the information processing apparatus 10 is connected to a multifunctional peripheral device (MFP) 50 via the LAN, and a storage apparatus 60 is connected to the MFP 50 by USB. The MFP 50 has a touch panel 501 as the internal device, which is connected to the internal bus 206 through the input I/F 207 and the display I/F 209.

In the example shown in the figure, the MFP 50 includes a printer 502, a scanner 503 and a FAX 504. Further, the storage apparatus 60 has an encryption information storing unit 602, an encryption data unit 603, a decryption module 604 and the communication I/F 302, and medium identification information 601 described later is set to the storage apparatus 60.

In this embodiment, the MFP 50 has the touch panel 501 having functions of the input device 208 and the display device 210 explained with reference to FIG. 1. The function corresponding to the input device 208 is connected to the internal bus 206 through the input I/F 207, and the function corresponding to the display device 210 is connected to the internal bus 206 through the display I/F 209, and the functions operate according to control from the CPU. In this embodiment, virtualization control of the touch panel 501 using the information processing apparatus 10 realizes remote control of the information processing apparatus 10 by the touch panel 501. Further, by performing virtualization control on the storage apparatus 60 connected to the MFP 50 by the information processing apparatus 10 to remotely operate the information processing apparatus 10 from the touch panel 501 of the MFP 50, encryption of the storage apparatus 60 is released. Image data read in cooperation with a scanner function of the MFP 50 is encrypted and stored in the storage apparatus 60. Further, encrypted data in the storage apparatus 60 is printed in cooperation with a printer function of the MFP 50.

The application 101 of the information processing apparatus 10 includes software for using the storage apparatus 60. It should be noted that the information processing apparatus 10 automatically activates the software when receiving, from the device control apparatus 20, a notification regarding the external device 30 being connected (hereinafter, the software will be also merely referred to as “application 101” for convenience of explanation).

As described above, the storage apparatus 60, which is, for example, a portable storage medium (hereinafter, referred to as a “USB memory”) having an encryption function of encrypting data and storing the encrypted data, includes the medium identification information 601, and has the encryption information storing unit 602, the encryption data unit 603, the decryption module 604 and the communication I/F 302.

For example, identification information such as a vendor ID, a product ID and a serial number allocated to the storage apparatus 60 is used as the medium identification information 601. In the encryption information storing unit 602, encryption information for decrypting data encrypted by the storage apparatus 60 is stored. It should be noted that the encryption information storing unit 602 receives an encryption release request from the information processing apparatus 10 and allows the encryption data unit 603 to read/write data. The encryption data unit 603 encrypts data based on the encryption information stored in the encryption information storing unit 602 and stores the encrypted data.

The decryption module 604 which is software operating by being loaded to a storing unit of the information processing apparatus 10, displays an encryption information input screen (described later) at a display device (not shown) such as a liquid crystal monitor connected to the information processing apparatus 10. Further, the decryption module 604 verifies encryption information input to the encryption information input screen with the encryption information stored in the information processing apparatus 10. The communication I/F 302 controls transmission/reception of the encrypted data with the MFP 50.

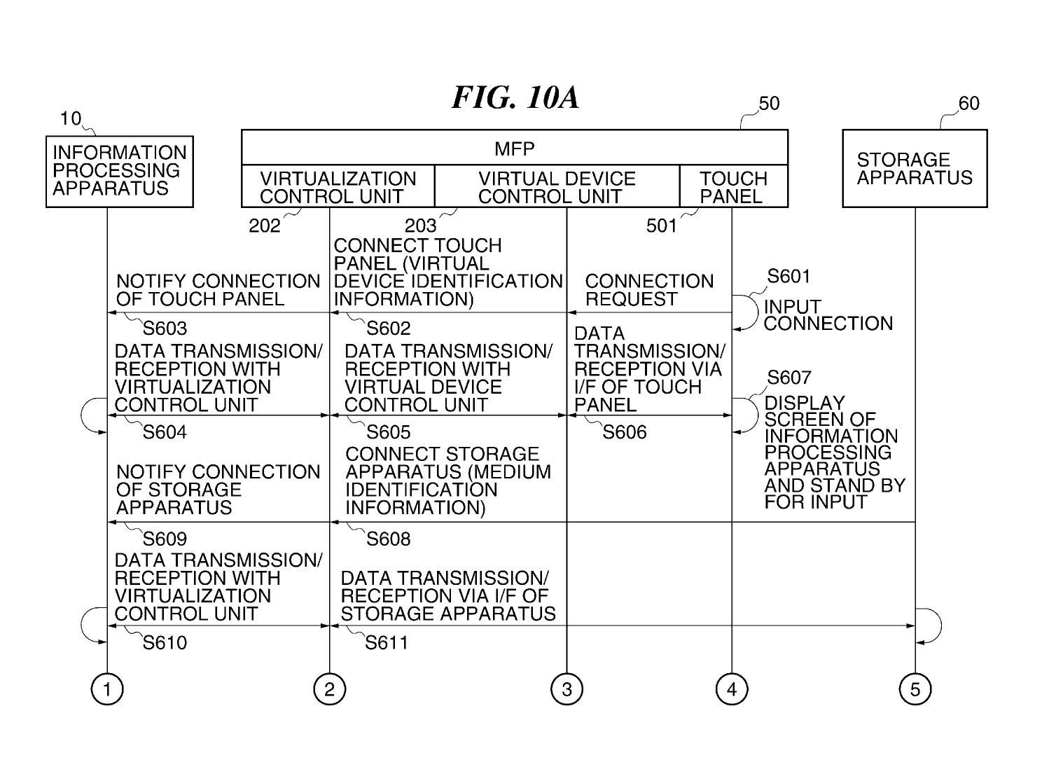

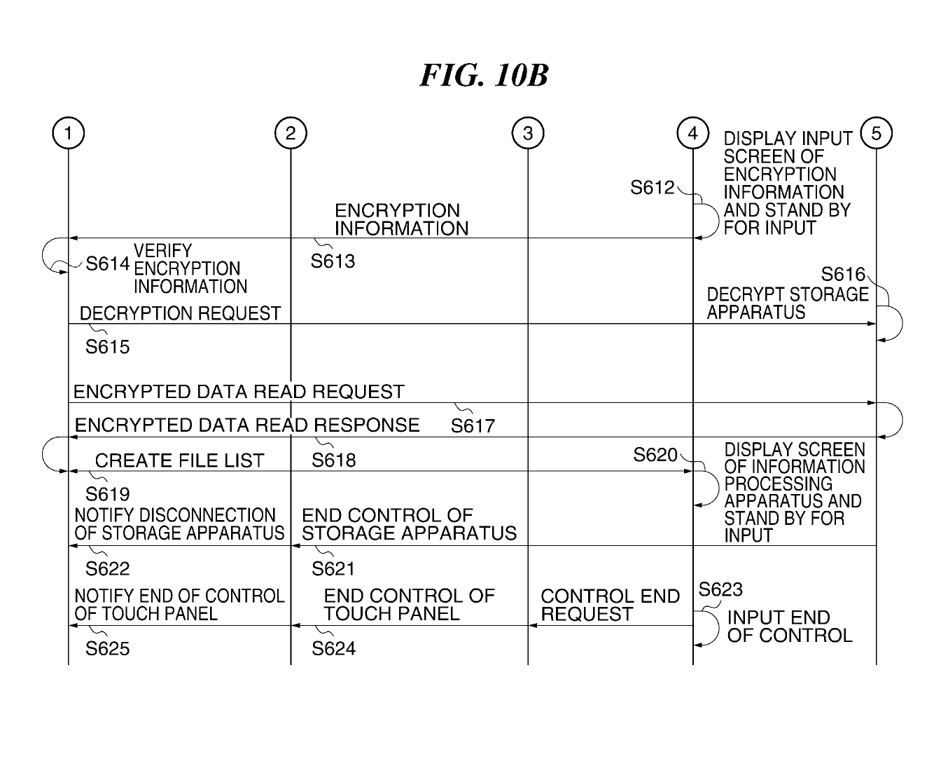

FIGS. 10A and 10B are sequence diagrams useful in explaining an operation when virtualization control is performed on the storage apparatus 60 and the touch panel 501 from the information processing apparatus 10 in the device control system shown in FIG. 9.

Here, it is assumed that an operation screen is displayed on the touch panel 501 through a predetermined user operation.

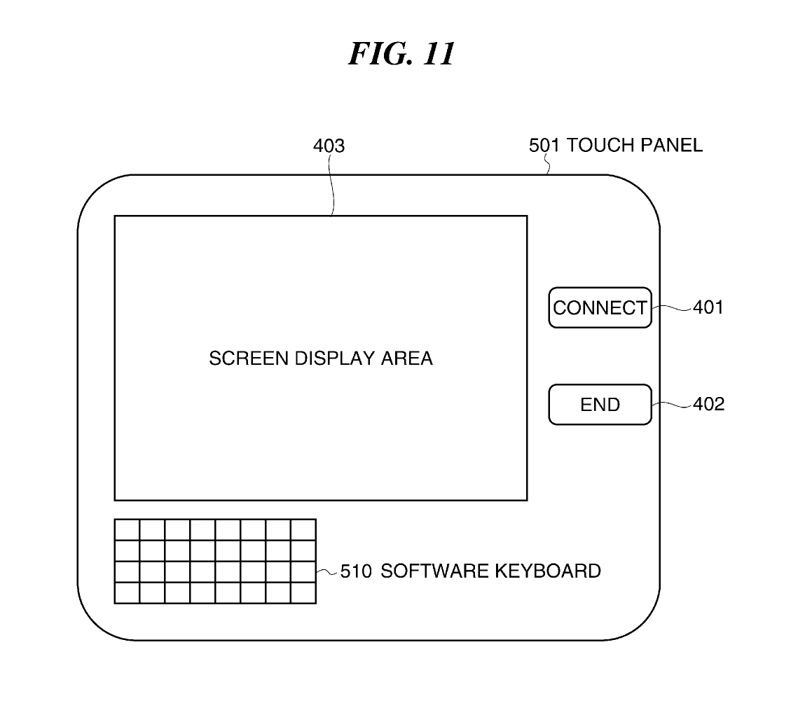

FIG. 11 is a drawing showing an example of the operation screen displayed on the touch panel 501 which is the display device 210. The explanation will be omitted because the components other than a software keyboard 510 are the same as those shown in FIG. 4. The operation screen of FIG. 11 is displayed on the touch panel 501 when the user executes the predetermined operation, and is comprised of the connect button 401, the end button 402, the screen display area 403 and the software keyboard 510 for input operation. The software keyboard 510 is displayed on the touch panel 501 in a similar manner to the connect button 401 and the end button 402 and enables input operation equivalent to that performed by a physical keyboard and mouse.

The user instructs virtualization control of the touch panel 501 by depressing the connect button 401 displayed on the touch panel 501 (step S601). That is, the user requests connection by depressing the connect button 401 in the operation screen.

In response to the above-described connection request, the virtual device control unit 203 notifies the virtualization control unit 202 of connection by transmitting the virtual device identification information 204 associated with the touch panel 501 to the virtualization control unit 202 (step S602). For example, three USB descriptors for the keyboard, the mouse and the display shown in FIG. 2 are transmitted as the virtual device identification information 204. The virtualization control unit 202 then notifies the information processing apparatus 10 that the touch panel 501 is connected (step S603).

The information processing apparatus 10 starts virtualization control of the touch panel 501 through the virtualization control unit 202 and starts data transmission/reception with the virtualization control unit 202 (step S604). By this means, the virtualization control unit 202 starts data transmission/reception with the virtual device control unit 203 (step S605).

The data format converting processing unit 205 of the virtual device control unit 203 converts USB data transmitted from the virtualization control unit 202 into a data format for the touch panel 501, and starts data transmission/reception with the touch panel 501 through the input I/F 207 and the display I/F 209 (step S606). A screen according to the screen data transmitted from the information processing apparatus 10 is displayed at the screen display area 403 of the touch panel 501, and the touch panel 501 stands by for input to the information processing apparatus 10 (step S607).

When the storage apparatus 60 is connected to the MFP 50 (step S608), the medium identification information 601 stored in the storage apparatus 60 is transmitted to the virtualization control unit 202 of the device control apparatus 20 to thereby notify connection of the storage apparatus 60. The virtualization control unit 202 then notifies the information processing apparatus 10 that the storage apparatus 60 is connected (step S609).

The information processing apparatus 10 starts virtualization control of the storage apparatus 60 through the virtualization control unit 202 and starts data transmission/reception with the virtualization control unit 202 (step S610). The virtualization control unit 202 starts data transmission/reception with the storage apparatus 60 through the communication I/F 302 (step S611).

When the virtualization control of the storage apparatus 60 is started by the device control apparatus 20, the application 101 of the information processing apparatus 10 is automatically activated and displayed at a liquid crystal monitor (not shown) connected to the information processing apparatus 10. As in the first embodiment, the screen data displayed at this liquid crystal monitor is transmitted to the device control apparatus 20, and image data transmitted from the information processing apparatus 10 is displayed on the touch panel 501.

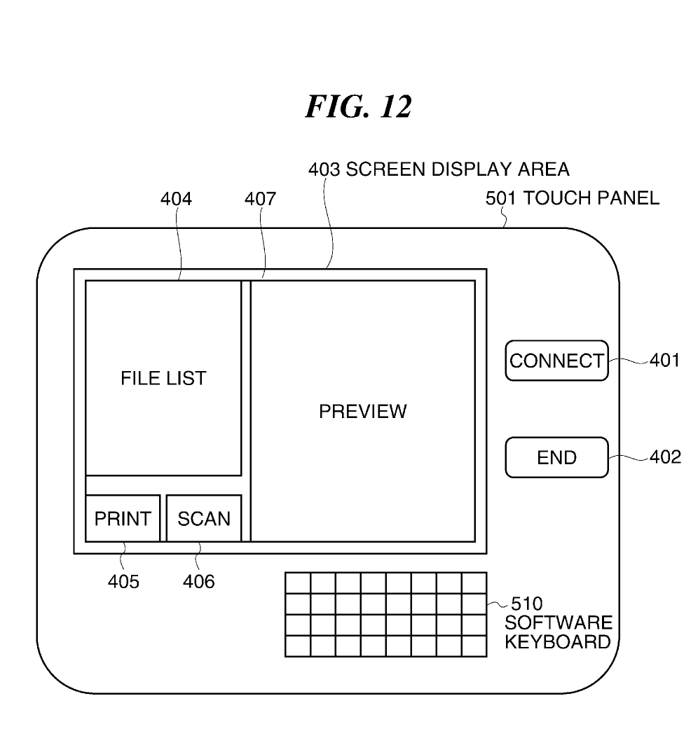

FIG. 12 is an example of a screen displayed on the touch panel 501 of the device control apparatus 20.

A screen of the application 101 activated at the information processing apparatus 10 is comprised of a file list screen 404 indicating a list of files within the USB memory, a preview screen 407 indicating a preview of the selected file, a print button 405 for instructing printing of the selected file, and a scan button 406 for storing the scanned image in the USB memory, and is displayed at the screen display area 403 of the touch panel 501. Through operation of the software keyboard 510 displayed on the touch panel 501, it is possible to make the information processing apparatus 10 instruct execution of key input, file selection, printing and scanning.

Subsequently, the user remotely operates the information processing apparatus 10 using the touch panel 501 to load the decryption module 604 (software) of the storage apparatus 60 to the storing unit 11 of the information processing apparatus 10, thereby displaying the encryption information input screen. By this means, the encryption information input screen displayed at the information processing apparatus 10 is displayed at the screen display area 403 of the touch panel 501 of the device control apparatus 20 (step S612).

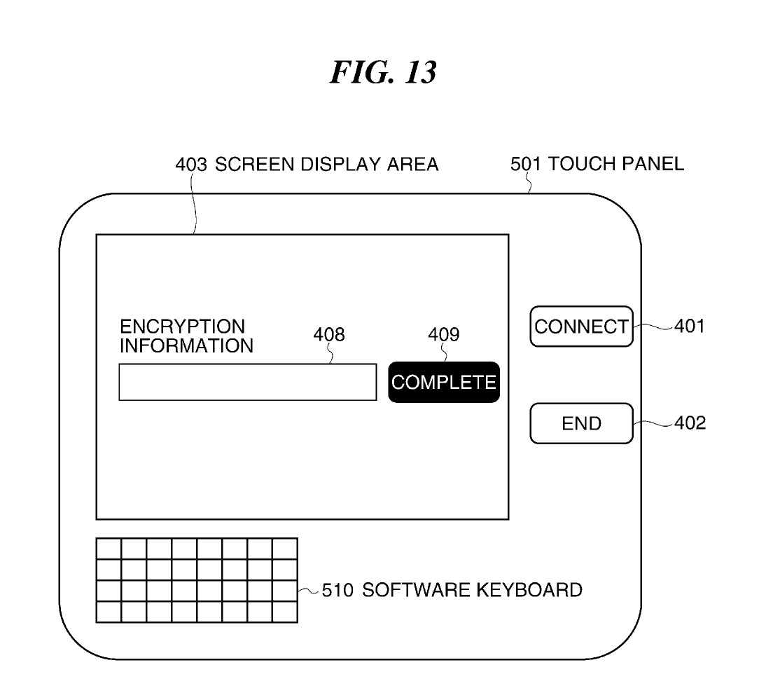

FIG. 13 is a diagram showing an example of the encryption information input screen displayed at the screen display area 403 of the touch panel 501 shown in FIG. 11.

As shown in FIG. 13, a text box 408 for receiving input of an encryption information for decryption and a complete button 409 for notifying completion of input are displayed at the encryption information input screen. The user inputs the encryption information associated with the storage apparatus 60 to the text box 408 using the software keyboard 510. Further, when the input of the encryption information is completed, the user depresses the completion button 409 to determine input of the encryption information.

When the user inputs the encryption information associated with the storage apparatus 60 through the encryption information input screen (step S613), the decryption module 604 loaded to the storing unit 11 of the information processing apparatus 10 verifies whether the encryption information input in the step S613 matches the encryption information stored in the encryption information storing unit 602 in advance (step S614), and when the two pieces of encryption information match each other, requests the storage apparatus 60 to perform decryption (step S615). By this means, the storage apparatus 60 is decrypted from this point (step S616).

Subsequently, the information processing apparatus 10 transmits an encrypted data read request to the storage apparatus 60 (step S617). By this means, the storage apparatus 60 transmits an encrypted data read response to the information processing apparatus 10 (step S618). The information processing apparatus 10 then generates file list data for allowing selection of the encrypted data read from the storage apparatus 60 and transmits the file list data to the MFP 50. The MFP 50 causes the data format converting processing unit 205 to subject the received file list data to converting processing and the converted file list data is displayed at the screen display area 403 of the touch panel 501 (step S619), and the touch panel 501 stands by for input to the information processing apparatus 10 (step S620).

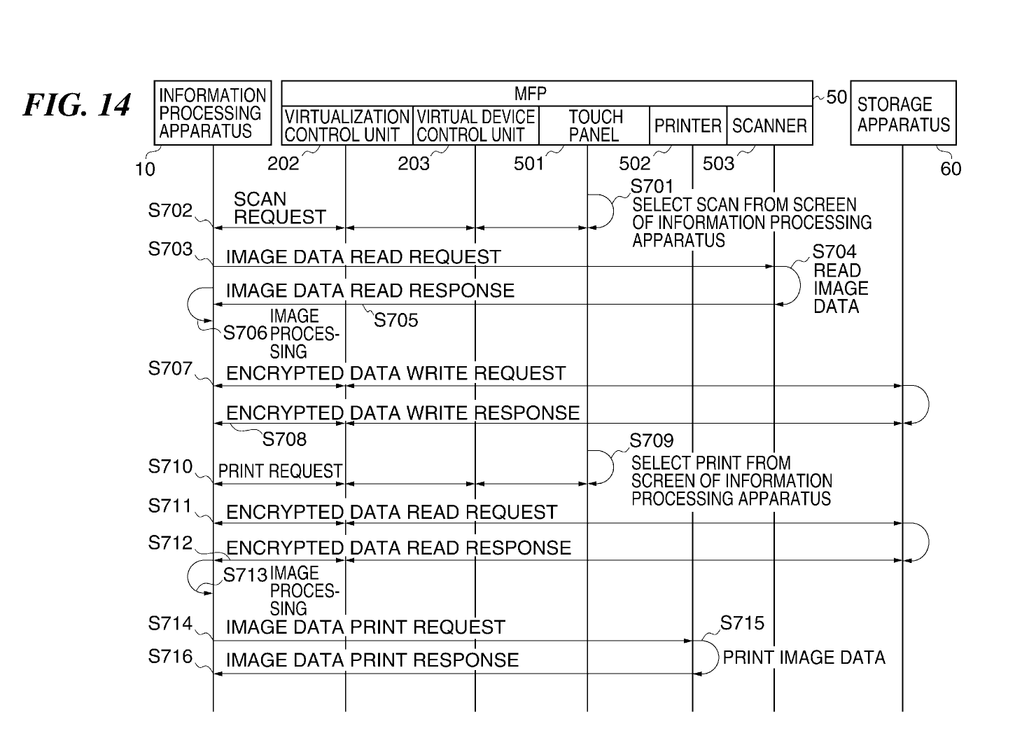

Here, an operation of remotely operating the information processing apparatus 10 to read image data using the scanner 503 provided at the MFP 50, store (write) the image data in the storage apparatus 60, read the image data from the storage apparatus 60 and print the image data using the printer 502 will be described with reference to a sequence diagram of FIG. 14.

FIG. 14 is a sequence diagram useful in explaining an operation of using the printer 502 and the scanner 503 provided at the MFP 50 by performing virtualization control on the storage apparatus 60 and the touch panel 501 from the information processing apparatus 10 in the device control system shown in FIG. 9.

Here, it is assumed that a screen of the application 101 explained using FIG. 12 is displayed on the touch panel 501. When the user selects, that is, depresses the scan button 406 through the software keyboard 510 (step S701), the information processing apparatus 10 receives a scan request and starts operation of reading image data (step S702). The information processing apparatus 10 then transmits an image data read request to the scanner 503 (step S703). In response to this request, the scanner 503 starts processing of reading the image data (step S704).

Subsequently, the scanner 503 transmits an image data read response to the information processing apparatus 10 (step S705). In response to this request, the information processing apparatus 10 performs image processing on the image data obtained in the step S705 (step S706). The information processing apparatus 10 encrypts the processed image data and transmits a write request to the storage apparatus 60 (step S707).

In response to the write request, the storage apparatus 60 transmits a write response to the information processing apparatus 10 (step S708). Subsequently, the user selects the print button 405 at the screen of the information processing apparatus 10 (step S709). By this means, the information processing apparatus 10 receives a print request and starts a printing operation associated with the image data (step S710).

Subsequently, the information processing apparatus 10 transmits an encrypted data read request to the storage apparatus 60 (step S711). The storage apparatus 60 transmits an encrypted data read response to the information processing apparatus 10 (step S712).

The information processing apparatus 10 performs image processing on the image data according to the response in the step S712 (step S713). The information processing apparatus 10 transmits an image data print request to the printer 502 (step S714). In response to this request, the printer 502 performs printing according to the image data (i.e., print data which is the processed image data) (step S715). The printer 502 then transmits an image data print response to the information processing apparatus 10 (step S716) and the processing ends.

Returning to the sequence diagram of FIG. 10B, when the storage apparatus 60 is disconnected from the MFP 50 through a user operation, or the like (step S621), the virtualization control unit 202 of the device control apparatus 20 notifies the information processing apparatus 10 that the storage apparatus 60 is disconnected (step S622). Further, the user depresses the end button 402 displayed on the touch panel 501 and ends the virtualization control of the touch panel 501 (step S623).

Subsequently, the virtual device control unit 203 notifies the virtualization control unit 202 that the virtualization control of the touch panel 501 ends, and ends data transmission/reception with the touch panel 501 (step S624). The virtualization control unit 202 then notifies the information processing apparatus 10 that the virtualization control of the touch panel 501 ends (step S625).

In this way, in the second embodiment of the present invention, by performing virtualization control on the touch panel 501 provided at the MFP 50 and the storage apparatus 60 (USB memory) connected to the MFP 50 using the information processing apparatus 10, it is possible to utilize the functions (a printer, a scanner and a FAX) of the MFP 50 and the touch panel and the storage apparatus under virtualization control in cooperation with each other.

Although the present invention has been described based on the above-described embodiments, the present invention is not limited to the above-described embodiments and includes various embodiments without departing from the scope of the invention.

For example, it is also possible to make the device control apparatus implement a control method of the functions in the above-described embodiments. Further, it is also possible to make a computer provided at the device control apparatus implement a control program having the functions in the above-described embodiments. The control program is, for example, recorded in a computer-readable recording medium.

Further, the present invention can be implemented by executing the following processing: supply software (program) which realizes the functions in the above-described embodiments to a system or an apparatus via a network or various recording media, and read and implement the program by the system or a computer (or a CPU, a MPU, or the like) of the apparatus.

This application is a bypass continuation application of PCT International Application PCT/JP2013/078888 filed on Oct. 18, 2013 which is based on and claims priority from Japanese Patent Application No. 2012-232740, filed Oct. 22, 2012, and Japanese Patent Application No. 2013-208659, filed Oct. 3, 2013, the contents of which are hereby incorporated by reference herein in their entirety.

What is claimed is:

1. A device control apparatus connected to an information processing apparatus via a network, comprising:
an identification information storing means which stores virtual device identification information identified for recognizing a predetermined function of the device control apparatus as an internal device connected to the device control apparatus;
an identification information transmitting means which transmits the virtual device identification information to the information processing apparatus; and
a virtualization control means which controls the internal device recognized based on the virtual device identification information by the information processing apparatus according to a control request from the information processing apparatus while converting data communication between the internal device and the device control apparatus into a first data format and converting data communication between the information processing apparatus and the device control apparatus into a second data format.

2. The device control apparatus according to claim 1, wherein when a predetermined connection operation is performed in the device control apparatus, the identification information transmitting means transmits the virtual device identification information to the information processing apparatus according to the predetermined connection operation.

3. The device control apparatus according to claim 2, wherein when a predetermined end operation is performed in the device control apparatus, the virtualization control means ends control of the internal device.

4. The device control apparatus according to claim 1, wherein when a device is connected to the device control apparatus,
the identification information transmitting means further transmits individual identification information transmitted from the device to the information processing apparatus, and
the virtualization control means further controls the device recognized by the information processing apparatus based on the individual identification information according to a control request from the information processing apparatus.

5. A control method of a device control apparatus connected to an information processing apparatus via a network,
the device control apparatus comprising an identification information storing means which stores virtual device identification information identified for recognizing a predetermined function of the device control apparatus as an internal device connected to the device control apparatus,
the method comprising:
an identification information transmitting step of transmitting the virtual device identification information to the information processing apparatus; and
a virtualization control step of controlling the internal device recognized based on the virtual device identification information by the information processing apparatus according to a control request from the information processing apparatus, while converting data communication between the internal device and the device control apparatus into a first data format and converting data communication between the information processing apparatus and the device control apparatus into a second data format.

6. The control method according to claim 5, wherein when a predetermined connection operation is performed in the device control apparatus, the virtual device identification information is transmitted to the information processing apparatus according to the predetermined connection operation in the identification information transmitting step.

7. The control method according to claim 6, wherein when a predetermined end operation is performed in the device control apparatus, control of the internal device is ended in the virtualization control step.

8. The control method according to claim 5, wherein when a device is connected to the device control apparatus,
individual identification information transmitted from the device is further transmitted to the information processing apparatus in the identification information transmitting step, and
the device recognized by the information processing apparatus is further controlled in the virtualization control step based on the individual identification information according to a control request from the information processing apparatus.
